(19) United States
(12) Patent Application Publication
(10) Pub. No.: US 2009/0172354 A1
(43) Pub. Date: Jul. 2, 2009

(54) HANDSHAKING DUAL-PROCESSOR ARCHITECTURE OF DIGITAL CAMERA

(75) Inventor: Chao-Tsung Tsai, Jhudong Township (TW)

Correspondence Address: Workman Nydegger;1000 Eagle Gate Tower, 60 East South Temple, Salt Lake City, UT, 84111, US

(73) Assignee: Altek Corporation, Hsinchu (TW)

(21) Appl. No.: 12/054,163

(22) Filed: Mar. 24, 2008

(30) Foreign Application Priority Data
Dec. 26, 2007 (TW) 096150371

(51) Int. Cl. G06F 15/76; G06F 9/30

(52) U.S. Cl. 712/35; 712/E09.016

(57) ABSTRACT

A handshaking dual-processor architecture of a digital camera includes a microprocessor and a digital signal processor (DSP). After accepting a user command, the microprocessor transmits a wakeup signal to trigger the DSP to switch from a sleep mode to an operation mode, and transmits a data packet and a processing request to the DSP. After receiving the data packet, the DSP generates a data packet processing result according to the processing request. After receiving the data packet processing result, the microprocessor returns a processing state in response to the user command. Through the handshaking dual-processor architecture, it is unnecessary to implement low-level device operation on application program, and it is only necessary to submit a required basic function, such that the microprocessor controls the corresponding DSP to execute the basic function and report the executing result of the basic function.

### CROSS-REFERENCE TO RELATED APPLICATIONS

This non-provisional application claims priority under 35 U.S.C. § 119(a) on Patent Application No(s). 096150371 filed in Taiwan, R.O.C. on Dec. 26, 2007, the entire contents of which are hereby incorporated by reference.

### BACKGROUND OF THE INVENTION

1. Field of Invention

The present invention relates to a processor architecture, and more particularly to a handshaking dual-processor architecture of a digital camera.

2. Related Art

Conventional camera shoots static pictures by film photosensitization, merely for recording object images. As the digital camera technology is developed, shooting is not only the image record, further the subsequent processing is performed on the shot image by a microprocessor of the digital camera. For example, in some digital cameras, frames can be added to pictures. Alternatively, through a man-machine interface of the digital camera, the portrait image in the picture can be partially enlarged and displayed on a screen of the digital camera for browsing. Recently, in addition to a microprocessor for controlling execution of various functions, most digital cameras are provided with at least one digital signal processor (DSP), for exclusively processing a single function, for example, image post-processing function, digital anti-shake function, noise restrain function, false color elimination function, or other additional functions, such that the functions of the digital camera are further diversified.

Recently, various types of digital cameras have the microprocessor and the DSP. FIG. 1 is a schematic view of a dual-processor architecture of a conventional digital camera. Referring to FIG. 1, the digital camera provides a human-machine interface 110 for the user to select to execute an application program 130. The digital camera has a microprocessor 120, a DSP 140, and a low-level device 150. After an operation instruction is received from the human-machine interface 110, the microprocessor 120 is triggered to control the execution of the application program 130. The microprocessor 120 further assigns a portion of the functions, for example, restraining of noise spots in the shot digital image, to the DSP 140 for execution. During the execution process, if the low-level device is required, for example, displaying the image after the noise restraining process on the screen, the DSP 140 directly controls the low-level device 150 to actuate. However, the dual-processor architecture (the microprocessor 120 and the DSP 140) has disadvantages that it is not easy to expand the application program 130, the maintenance is complicated, and the design is not flexible etc. If it intends to expand a new function on the application program 130, the designer must start to develop the function after knowing the actuation manner between the processor 140 and the low-level device 150. In other words, the complexity for developing or maintaining the application program on the recent dual-processor architecture by the system developer is extremely high.

### SUMMARY OF THE INVENTION

Due to insufficient expansion flexibility of application program and extremely high maintaining complexity of the dual-processor architecture of the digital camera, the present invention is directed to provide a handshaking dual-processor architecture of a digital camera, in which by assigning a user command to be executed to a microprocessor, and executing a processing request to be executed by a digital signal processor (DSP) through assigning the processing request to the microprocessor in a handshaking conversation manner, the command to be executed can be executed by an application program without actuating a low-level device, and thus acquiring a result of the execution.

As embodied and broadly described herein, the handshaking dual-processor architecture of the digital camera of the present invention includes a microprocessor and a DSP. After accepting a user command, the microprocessor transmits a wakeup signal to trigger the DSP to switch from a sleep mode to an operation mode, and transmits data packets and a processing request to the DSP After receiving the data packets, the DSP executes and generates a data packet processing result according to the processing request. After receiving the data packet processing result, the microprocessor returns a processing state in response to the user command.

In the handshaking dual-processor architecture of the digital camera according to a preferred embodiment of the present invention, the digital camera includes a human-machine interface for receiving the input user command through the human-machine interface.

In the handshaking dual-processor architecture of the digital camera according to a preferred embodiment of the present invention, the DSP further automatically switches from the operation mode to the sleep mode after returning the data packet processing result to the microprocessor.

In the handshaking dual-processor architecture of the digital camera according to a preferred embodiment of the present invention, the processing request includes a procedure start request, a procedure wait request, and a procedure stop request. After initializing the processing request, the microprocessor delivers the processing request to the DSP.

In the handshaking dual-processor architecture of the digital camera according to a preferred embodiment of the present invention, the data packet further records an original data saving address, and the DSP acquires original data to be processed through the original data saving address.

In the handshaking dual-processor architecture of the digital camera according to a preferred embodiment of the present invention, the data packet processing result includes a processing result message, a processing result saving address, and a processing result data type.

In view of the above, the handshaking dual-processor architecture of the digital camera of the present invention provides a quick design/maintenance application program system platform for program designers of digital cameras. The application program is operated on the microprocessor, when executing the application program, the microprocessor receives a user command and assigns a working task to the DSP for execution in a handshaking manner of delivering the signal/packet, and the microprocessor is informed an execution result of the working task by returning the signal/packet. The microprocessor does not directly perform the intercommunication operation with the low-level device, so when the application program is designed/maintained, it is unnecessary to implement the part corresponding to the low-level device, thereby improving the expandability of the camera system and reducing the complexity of maintaining the application program.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a dual-processor architecture of a conventional digital camera;

FIG. 2 is a schematic view of a dual-processor architecture of a digital camera according to a preferred embodiment of the present invention; and

FIG. 3 is a timing chart of operation of the dual-processor architecture according to a preferred embodiment of the present invention.

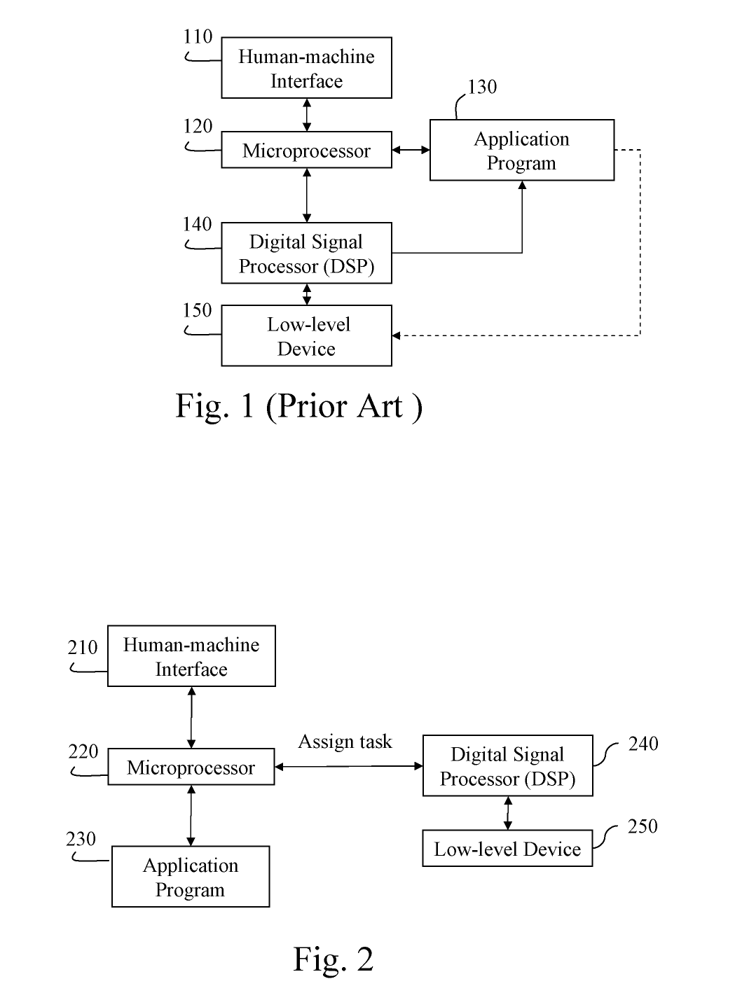

### DETAILED DESCRIPTION OF THE INVENTION

Detailed description of the objective and the provided content of the present invention is given in the preferred embodiment in the following. However, the concept of the present invention can also be used in other scope. The exemplified embodiments in the following are only used to describe the objective and the executing method of the present invention, and are not used to limit the scope.

FIG. 2 is a schematic view of a dual-processor architecture of a digital camera according to a preferred embodiment of the present invention. Referring to FIG. 2, the digital camera of this embodiment has a human-machine interface 210 for receiving an input user command. The digital camera has a microprocessor 220 for executing a selected application program 230, and the application programs 230 are, for example, bad pixel recovery in the shot image or the false color restrain in the shot image etc. When the microprocessor 220 executes the application program 230, a portion of the image processing procedures, for example, a procedure of determining bad spots of the image, are assigned to the DSP 240 for execution. During the execution, the DSP 240 directly actuates with a low-level device 250, and sends back a processing result to the microprocessor 220. The actuation relation of the low-level device 250 is executed by the DSP 240, so when a function is newly added to the application program by application program designers/maintainers, it is unnecessary to implement the function corresponding to the low-level device 250, and thus the system architecture is further expandable as compared with the dual-processor architecture of the recent digital camera.

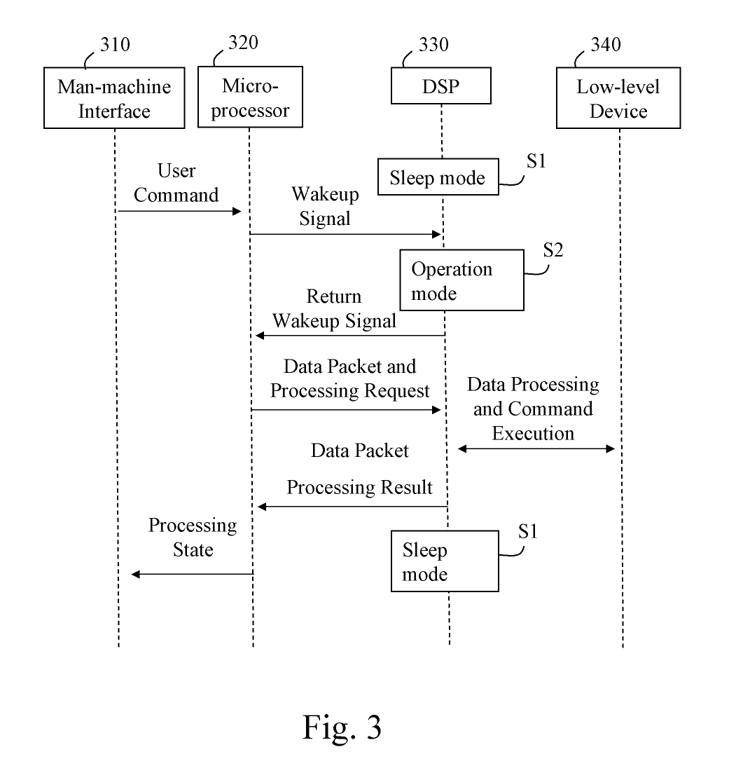

Next, a practical operation flow of the handshaking dual-processor architecture of the digital camera of the present invention is described through the accompanying drawings. FIG. 3 is a timing chart of operation of the dual-processor architecture according to a preferred embodiment of the present invention. Referring to FIG. 3, after the user inputs the user command through the human-machine interface 310, the microprocessor 320 receives the user command, and triggers related application procedure. For example, after the image is shot, an image red eye filtering function is selected through a user menu, the microprocessor 320 initiates the function of filtering bad spots in the image, so as to filter the pixels, which may be the red eye in the image. Next, the microprocessor 320 captures and assigns the function of filtering the bad spots in the image, which must be processed by the DSP 330, to the DSP for execution.

In this embodiment, the DSP has a power-saving function, after the digital camera is started, the DSP enters a sleep mode S1 to save power consumption. Before transmitting a processing request, the microprocessor firstly transmits a wakeup signal, so as to trigger the DSP to switch from the sleep mode S1 to an operation mode S2. After receiving the wakeup signal, the DSP 330 transmits a return wakeup signal to the microprocessor 320, thereby informing that a processing request can be transmitted to the DSP 330. After receiving the return wakeup signal, the microprocessor 320 firstly initialize an available processing request, and in this embodiment, the processing request is procedure start request, procedure wait request, or procedure stop request. After the processing request is initialized, the microprocessor 320 sends the data packets and the processing request to the DSP 330. The content of the data packet further includes original data saving address, and the DSP 330 acquires original data to be processed through the original data saving address, and calls to use the low-level device 340 to execute the corresponding instruction, such as memory operation, or displaying processing message on the screen of the camera.

After the original data processing is finished or the instruction execution is finished, the DSP 330 generates a data packet processing result according to the result after the processing request is executed. The data packet processing result includes processing result message, processing result saving address, and processing result data type. After receiving the data packet processing result, the microprocessor 320 directly captures the processed data (for example the image after bad spot recovery) from the processing result saving address. At this time, the DSP 330 switches from the operation mode S2 to the sleep modes S1, so as to save the power consumption. After receiving the data packet processing result, the microprocessor 320 returns the processing state of the human-machine interface 310, so as to prompt the user to inspect the execution result corresponding to the assigned user command.

What is claimed is:

1. A handshaking dual-processor architecture of a digital camera, comprising:
a microprocessor and a digital signal processor (DSP), wherein the microprocessor transmits a wakeup signal after accepting a user command, so as to trigger the DSP to switch from a sleep mode to an operation mode, the microprocessor transmits a plurality of data packets and at least one processing request to the DSP, the DSP generates a data packet processing result according to the processing request after receiving the data packets, and the microprocessor returns a processing state in response to the user command after receiving the data packet processing result.

2. The handshaking dual-processor architecture of a digital camera as claimed in claim 1, wherein the digital camera further comprises a human-machine interface for receiving the input user command.

3. The handshaking dual-processor architecture of a digital camera as claimed in claim 1, wherein the DSP further switches from the operation mode to the sleep mode after returning the data packet processing result.

4. The handshaking dual-processor architecture of a digital camera as claimed in claim 1, wherein the processing request is one selected from a group consisting of a procedure start request, a procedure wait request, and a procedure stop request.

5. The handshaking dual-processor architecture of a digital camera as claimed in claim 1, wherein the data packets further comprise an original data saving address, and the DSP acquires original data to be processed through the original data saving address.

6. The handshaking dual-processor architecture of a digital camera as claimed in claim 1, wherein the data packet processing result comprises a processing result message, a processing result saving address, and a processing result data type.
